(19) United States
(12) Patent Application Publication
(10) Pub. No.: US 2026/0160114 A1
(43) Pub. Date: Jun. 11, 2026

(54) METHOD AND APPARATUS FOR CONTROLLING A VEHICLE DOOR

(71) Applicants: Hyundai Motor Company, Seoul (KR); Kia Corporation, Seoul (KR)

(72) Inventors: Hoongi Lee, Hwaseong-si (KR); Hyoeun Jung, Hwaseong-si (KR); Gwangseob Kim, Hwaseong-si (KR); Chan Seok Choi, Hwaseong-si (KR)

(21) Appl. No.: 19/410,895

(22) Filed: Dec. 5, 2025

(30) Foreign Application Priority Data
Dec. 6, 2024 (KR) 10-2024-0180514

(51) Int. Cl. E05F 15/76; B60R 25/20; B60R 25/32; B60R 25/34

(52) U.S. Cl. CPC E05F 15/76; B60R 25/209; B60R 25/32; B60R 25/34; E05Y 2900/531

(57) ABSTRACT

A method for controlling a vehicle door can be performed by a first controller and a second controller implemented in a vehicle. The first controller determines whether a predetermined condition is satisfied. The first controller transmits a search request for a smart key to the second controller in response to determining that the predetermined condition is satisfied. The second controller attempts detection of the smart key in response to the search request. The second controller transmits a result of the detection attempt to the first controller. The first controller determines whether the smart key is located in the vehicle in response to the result of detection attempt. The first controller causes the power door of the vehicle to close in response to determining that the smart key is not located in the vehicle.

### CROSS-REFERENCE TO RELATED APPLICATION

This application claims priority to and the benefit of Korean Patent Application No. 10-2024-0180514 filed with the Korean Intellectual Property Office on Dec. 6, 2024, the entire contents of which is incorporated herein by reference.

### TECHNICAL FIELD

The present disclosure relates to a method and apparatus for controlling a vehicle door.

### BACKGROUND

In logistics and delivery cargo vehicles, digital key systems have been used that use the user's smartphone and a Bluetooth beacon installed in the vehicle to control the opening and closing of doors. The system can work by automatically locking or unlocking the doors by recognizing signals from the digital key on the smartphone as it moves away from or approaches the vehicle. However, Bluetooth communication may become unstable due to signal interference, distance changes, environmental factors, etc., and such communication instability may reduce the reliability of door control.

### SUMMARY

Embodiments of the present disclosure describes an improved system that can perform door control stably. For example, embodiments of the present disclosure attempt to provide a method and apparatus for controlling a vehicle door capable of controlling a vehicle door by using the smart key low frequency (LF) communication.

An embodiment provides a method for controlling a vehicle door. The method is performed by a first controller and a second controller implemented in a vehicle. The first controller determines whether a predetermined condition is satisfied. A search request for a smart key is transmitted from the first controller to the second controller in response to determining that the predetermined condition is satisfied. The second controller attempts detection of the smart key in response to the search request. A result of the detection attempt is transmitted from the second controller to the first controller. The first controller determines whether the smart key is located in the vehicle in response to the result of the detection attempt. The first controller causes a power door of the vehicle to be closed in response to determining that the smart key is not located in the vehicle.

The determining whether the predetermined condition is satisfied may include determining whether a smart walk away (SWA) is activated in the vehicle, determining whether the vehicle is stopped when it is determined that the SWA is activated in the vehicle, determining whether a driver seat of the vehicle is occupied or not, when it is determined that the vehicle is stopped, determining whether a remote start is inactivated when it is determined that the driver seat of the vehicle is not occupied, determining whether all other doors except for the power door are closed when it is determined that the remote start is inactivated, and determining that the predetermined condition is satisfied when it is determined that the all other doors are closed.

The transmitting, by the first controller, the search request for the smart key to the second controller may include reading, by the first controller, a predetermined period table, and transmitting, by the first controller, the search request for the smart key to the second controller, according to a search proceeding cycle and a search stopping cycle stored in the period table.

The transmitting, by the first controller, the search request for the smart key to the second controller may further include reading, by the first controller, a predetermined weight value table, and applying, by the first controller, a weight value depending on a smart key battery state, stored in the weight value table, to the search stopping cycle, where the transmitting the search request for the smart key to the second controller may include transmitting, by the first controller, the search request for the smart key to the second controller according to the search proceeding cycle stored in the period table and the search stopping cycle to which the weight value is applied.

The transmitting, by the first controller, the search request for the smart key to the second controller may further include stopping, by the first controller, transmitting the search request for the smart key to the second controller, when a preset search request allowance time has elapsed after an initial request was transmitted.

The attempting the detection of the smart key may include attempting, by the second controller, location detection of the smart key through a low frequency (LF) or radio frequency (RF) communication.

The attempting the detection of the smart key may include attempting the detection of the smart key multiple times, and the transmitting the result of detection attempt of the smart key to the first controller may include transmitting every result of the multiple times attempting to the first controller.

The determining whether the smart key exists in the vehicle may include determining that the smart key does not exist in the vehicle, when a result representing that the smart key is not detected, among the results of the multiple times attempting exists in number greater than or equal to a predetermined number.

The method may further include closing the power door and all other doors, after a predetermined time has elapsed after the power door of the vehicle is closed.

The method may further include inactivating or cancelling closing the power door of the vehicle and locking the all other doors, when an arbitrary button of the smart key is pressed, when a remote start is activated, and when a remote parking assist is activated, transmitting the search request for the smart key to the second controller.

An apparatus for controlling a vehicle door, including a first controller and a second controller implemented in a vehicle, may perform an operation that includes determining, by the first controller, whether a predetermined condition is satisfied, transmitting, by the first controller, a search request for the smart key to the second controller, when it is determined that the predetermined condition is satisfied, attempting, by the second controller, detection of the smart key, in response to the search request, transmitting, by the second controller, a result of detection attempt of the smart key to the first controller, determining, by the first controller, whether the smart key exists in the vehicle, in response to the result of detection attempt, and closing, by the first controller, a power door of the vehicle, when it is determined that the smart key does not exist in the vehicle.

The determining whether the predetermined condition is satisfied may include determining whether a smart walk away (SWA) is activated in the vehicle, determining whether the vehicle is stopped, when it is determined that the SWA is activated in the vehicle, determining whether a driver seat of the vehicle is occupied or not, when it is determined that the vehicle is stopped, determining whether a remote start is inactivated, when it is determined that the driver seat of the vehicle is not occupied, determining whether all other doors except for the power door are closed, when it is determined that the remote start is inactivated, and determining that the predetermined condition is satisfied, when it is determined that the all other doors are closed.

The transmitting, by the first controller, the search request for the smart key to the second controller may include reading, by the first controller, a predetermined period table, and transmitting, by the first controller, the search request for the smart key to the second controller according to a search proceeding cycle and a search stopping cycle stored in the period table.

The transmitting, by the first controller, the search request for the smart key to the second controller may further include reading, by the first controller, a predetermined weight value table, and applying, by the first controller, a weight value depending on a smart key battery state, stored in the weight value table, to the search stopping cycle, where the transmitting the search request for the smart key to the second controller may include transmitting, by the first controller, the search request for the smart key to the second controller according to the search proceeding cycle stored in the period table and the search stopping cycle to which the weight value is applied.

The transmitting, by the first controller, the search request for the smart key to the second controller may further include stopping, by the first controller, transmitting the search request for the smart key to the second controller, when a preset search request allowance time has elapsed after an initial request was transmitted.

The attempting the detection of the smart key may include attempting, by the second controller, location detection of the smart key through a low frequency (LF) or radio frequency (RF) communication.

The attempting the detection of the smart key may include attempting the detection of the smart key multiple times, and where the transmitting the result of detection attempt of the smart key to the first controller may include transmitting every result of the multiple times attempting to the first controller.

The determining whether the smart key exists in the vehicle may include determining that the smart key does not exist in the vehicle, when a result representing that the smart key is not detected, among the results of the multiple times attempting exists in number greater than or equal to a predetermined number.

The first controller may be configured to close the power door and all other doors, after a predetermined time has elapsed after the power door of the vehicle is closed.

The first controller may be configured to inactive or cancel transmitting the search request for the smart key to the second controller, closing the power door of the vehicle and locking the all other doors, when an arbitrary button of the smart key is pressed, when a remote start is activated, and when a remote parking assist is activated.

### BRIEF DESCRIPTION OF THE DRAWINGS

FIG. 1 is a drawing for explaining an apparatus for controlling a vehicle door according to an embodiment.

FIG. 2 is a drawing for explaining a method for controlling a vehicle door according to an embodiment.

FIG. 3 is a drawing for explaining a method for controlling a vehicle door according to an embodiment.

FIG. 4 to FIG. 6 are drawings for explaining an implementation example of an apparatus and method for controlling a vehicle door according to an embodiment.

FIG. 7 is a drawing for explaining a method for controlling a vehicle door according to an embodiment.

FIG. 8 is a drawing for explaining a computing device according to an embodiment.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, when a part “includes” a certain element, it means that other elements may be further included, rather than excluding other elements, unless otherwise stated. Terms including ordinal numbers such as first, second, and the like will be used only to describe various constituent elements, and are not to be interpreted as limiting these constituent elements. The terms are only used to differentiate one constituent element from other constituent elements

In addition, the term “module” disclosed in the present specification may mean a unit that may process at least one function or operation described in this specification, and this may be implemented by hardware, software, or a combination thereof. Additionally, at least some of the configurations or functions of a door control method and apparatus of a vehicle according to the embodiments described below may be implemented as a program or software, and the program or software may be stored in a computer-readable medium.

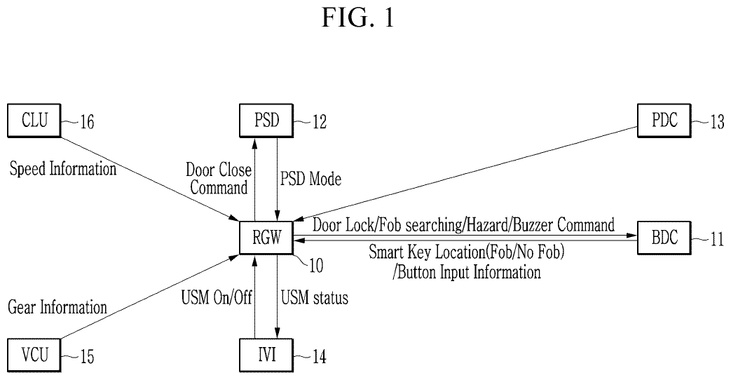

FIG. 1 is a drawing for explaining an apparatus for controlling a vehicle door according to an embodiment.

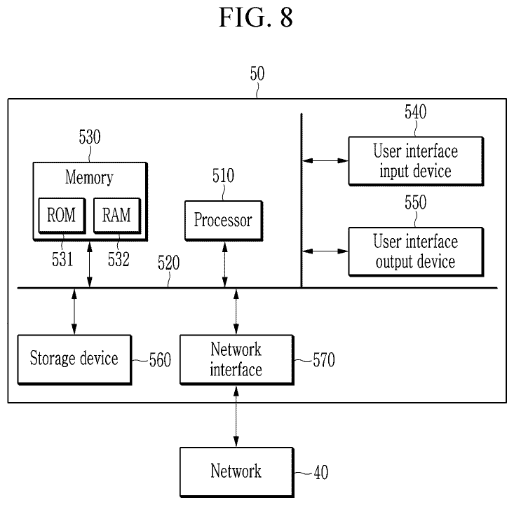

Referring to FIG. 1, an apparatus 10 for controlling a vehicle door according to an embodiment may be implemented as a computing device including a processor and memory. For example, the apparatus 10 for controlling a door may be implemented as a computing device 50, for example, as described later in connection with FIG. 8. Here, the computing device 50 may be implemented in a vehicle 1, for example, implemented as a controller mounted in the vehicle 1. In this case, the processor may correspond to a processor 510 of the computing device 50, and the memory may correspond to a memory 520 of the computing device 50. Alternatively, in some embodiments, the apparatus 10 for controlling a door may include one or more non-transitory computer-readable media including an instruction and one or more processors configured to perform an operation by executing the instruction. Here, the operation may include configurations, functions, steps, or the like described in this specification with respect to a method and apparatus for controlling a vehicle door according to embodiments.

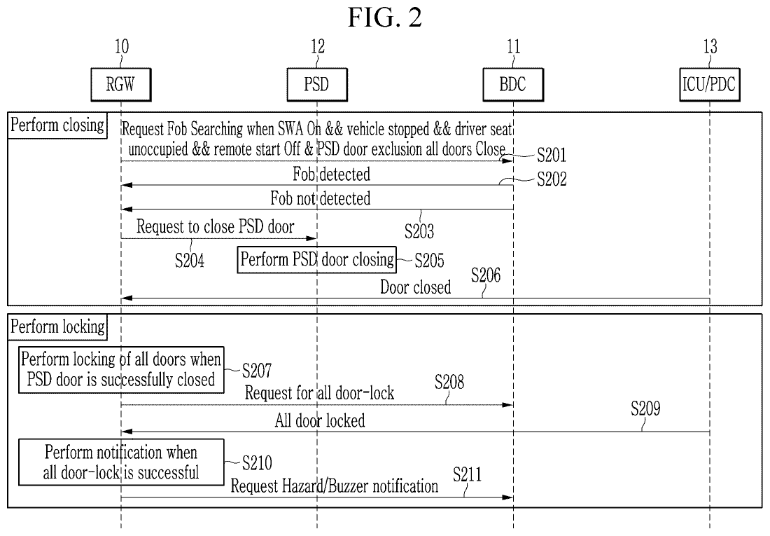

The apparatus for controlling a door may include a first controller 10 and a second controller 11 implemented within the vehicle 1, in order to control a vehicle door by using the smart key low frequency (LF) communication. As illustrated by FIG. 2, the first controller 10 may be a redundant gateway (RGW) and the second controller 11 may be a body domain controller (BDC). The first controller 10 and the second controller 11 may exchange data with a power sliding door (PSD) 12, a power-net domain controller (PDC) 13, an in-vehicle infotainment (IVI) 14 and a vehicle control unit (VCU) 15, implemented together within the vehicle 1, through an internal network. In some embodiments, internal network may include a controller area network (CAN), a local interconnect network (LIN), and an automotive ethernet, or the like. Here, for the sake of clarity and convenience of description, the power sliding door of the vehicle is mainly described, but the scope of the present disclosure may cover an arbitrary power door that is not limited to the sliding scheme.

The first controller 10 may transmit smart key location/button input information to the second controller 11, and the second controller 11 may transmit a door lock/smart key search/hazard/buzzer instruction to the first controller 10. In addition, the first controller 10 may transmit a door close command to the PSD 12, and may receive PSD mode information from the PSD 12. Meanwhile, the first controller 10 may receive a driver seat occupancy information and a door state (i.e. being closed, locked, or others) from the PDC 13.

The first controller 10 may receive turning on and off of a user-defined mode (USM) from the IVI 14, and may transmit the state of the user-defined mode to the IVI 14. In addition, the first controller 10 may receive gear information of vehicle from the VCU 15. Meanwhile, the first controller 10 may receive vehicle speed information from a cluster (CLU) 16.

In the apparatus 10 for controlling a door, the first controller 10 may determine whether a predetermined condition is satisfied, and when it is determined that the predetermined condition is satisfied, the first controller 10 may transmit a search request for the smart key to the second controller 11.

In some embodiments, in order to determine whether the predetermined condition is satisfied, the first controller 10 may determine whether the smart walk away (SWA) is activated in the vehicle, and when it is determined that the SWA is activated in the vehicle, may determine whether the vehicle stopped. When it is determined that the vehicle is stopped, the first controller 10 may determine whether the driver seat of the vehicle is occupied or not, and when it is determined that the driver seat of the vehicle is not occupied, the first controller 10 may determine whether a remote start is inactivated. When it is determined that the remote start is inactivated, the first controller 10 may determine whether all other doors except for a power door, for example, a power sliding door, are closed, and when it is determined that all other doors are closed, the first controller 10 may determine that the predetermined condition is satisfied.

In some embodiments, while the first controller 10 transmits the search request for the smart key to the second controller 11, the first controller 10 may read a predetermined period table, and may transmit the search request for the smart key to the second controller 11 according to a search proceeding cycle and a search stopping cycle stored in the period table.

In some embodiments, while the first controller 10 transmits the search request for the smart key to the second controller 11, the first controller 10 may read a predetermined weight value table, and may apply a weight value depending on a smart key battery state, stored in the weight value table, to the search stopping cycle. In this case, while the first controller 10 transmits the search request for the smart key to the second controller 11, the first controller 10 may transmit the search request for the smart key to the second controller 11 according to the search proceeding cycle stored in the period table and the search stopping cycle to which weight value is applied.

In some embodiments, while the first controller 10 transmits the search request for the smart key to the second controller 11, when a preset search request allowance time has elapsed after an initial request was transmitted, the first controller 10 may stop transmitting the search request for the smart key to the second controller 11.

Thereafter, the second controller 11 may attempt detection of the smart key, in response to the search request received from the first controller 10. The second controller 11 may transmit the result of detection attempt of the smart key to the first controller 10.

In some embodiments, when the second controller 11 attempts the detection of the smart key, the second controller 11 may attempt location detection of the smart key through low frequency (LF) or radio frequency (RF) communication.

In some embodiments, when the second controller 11 attempts the detection of the smart key, the second controller 11 may attempt the detection of the smart key multiple times, and when the second controller 11 transmits the result of detection attempt of the smart key to the first controller 10, the second controller 11 may transmit every result of the multiple times attempting to the first controller 10.

Thereafter, the first controller 10 may determine whether the smart key exists in the vehicle, in response to the result of detection attempt received from the second controller 11. When it is determined that the smart key does not exist in the vehicle, the first controller 10 may close a power door, for example, a power sliding door of the vehicle.

In some embodiments, when the first controller 10 determines whether the smart key exists in the vehicle, when the number of a result representing that the smart key is not detected among the results of the multiple times attempting is greater than or equal to a predetermined number, the first controller 10 may determine that the smart key does not exist in the vehicle.

Thereafter, the first controller 10 may lock the power door and all other doors, after a preset time is elapsed after the power door of the vehicle is closed.

In some embodiments, when an arbitrary button of the smart key is pressed, when the remote start is activated, and when the remote parking assist is activated, the first controller 10 may inactive or cancel transmitting the search request for the smart key to the second controller 11, closing a power door of the vehicle, and locking all other doors.

According to the present embodiment, by controlling a vehicle door by using the smart key LF communication, the problem of deteriorating stability caused by Bluetooth communication instability in the conventional smart phone and the Bluetooth beacon-based digital key system can be improved.

FIG. 2 is a drawing for explaining a method for controlling a vehicle door according to an embodiment.

Referring to FIG. 2, in order to perform an operation of closing a door in a method for controlling a vehicle door according to an embodiment, at step S201, when the SWA is activated, the vehicle is stopped, the driver seat is in an unoccupied state, the remote start is inactivated, and all other doors except for the PSD door are closed, the first controller 10 may transmit the search request for the smart key to the second controller 11. The second controller 11 may transmit the result representing that the smart key is detected to the first controller 10 at step S202, or may transmit the result representing that the smart key is not detected to the first controller 10 at step S203. At step S204, the first controller 10 may transmit a request to close the power sliding door of the vehicle to the PSD 12, and at step S205, the PSD 12 may close the power sliding door. Thereafter, at step S206, the ICU/PDC 13 may transmit the status that the door is closed to the first controller 10.

In order to perform an operation of locking the door in a method for controlling a vehicle door according to an embodiment, at step S207, when the power sliding door is successfully closed, the first controller 10 may perform locking of all other doors. At step S208, the first controller 10 may transmit a request for closing all doors to the second controller 11, and at step S209, the ICU/PDC 13 may transmit a status that all doors are closed to the first controller 10. At step S210, when all doors are successfully locked, the first controller 10 may perform notification, and at step S211, the first controller 10 may transmit a hazard/buzzer notification request to the second controller 11.

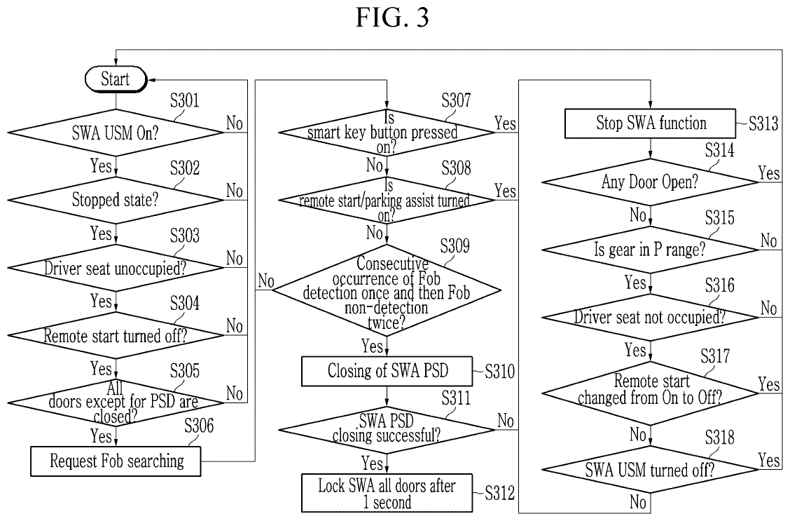

FIG. 3 is a drawing for explaining a method for controlling a vehicle door according to an embodiment.

Referring to FIG. 3, a method for controlling a vehicle door according to an embodiment may perform a step S301 of determining whether a SWA USM is activated. When it is determined that the SWA USM is activated (S301—Yes), the method may perform a step S302 of determining whether the vehicle stopped. When it is determined that the vehicle is stopped (S302—Yes), the method may perform a step S303 of determining whether the driver seat is in the unoccupied state. When it is determined that the driver seat is occupied (S303—Yes), the method may perform a step S304 of determining whether the remote start is inactivated. When it is determined that the remote start is inactivated (S304—Yes), the method may perform a step S305 of determining whether all other doors except for the PSD door are closed. When it is determined that all other doors except for the PSD door are closed (S305—Yes), the method may perform a step S306 of requesting the smart key search.

When it is determined that the SWA USM is not activated (S301—No), when it is determined that the vehicle is not stopped (S302—No), when it is determined that the driver seat is not in the unoccupied state (S303—No), when it is determined that the remote start is not inactivated (S304—No) or when it is determined that all other doors except for the PSD door are not closed (S305—No), the method may restart from the beginning.

After the step S306, the method may perform a step S307 of determining whether a button of the smart key is in an on-state. When it is determined that the button of the smart key is not in the on-state (S307—No), the method may perform a step S308 of determining whether the remote start/parking assist function is activated. When it is determined that the remote start/parking assist function is not activated (S308—No), the method may perform a step S309 of determining whether non-detection of the smart key has consecutively occurred twice after the detection of the smart key occurred once. When it is determined that the non-detection of the smart key has consecutively occurred twice after the detection of the smart key occurred once (S309—Yes), the method may perform a step S310 of performing a SWA PSD closing operation and a step S311 of determining whether the SWA PSD closing was successful. When it is determined that the SWA PSD closing was successful (S311—Yes), the method may perform a step S312 of performing the SWA all door locking operation after 1 second.

When it is determined that the button of the smart key is in the on-state (S307—Yes), when it is determined that the remote start/parking assist function is activated (S308—Yes), when it is determined that the SWA PSD closing was not successful (S311—No), the method may perform a step S313 of stopping the SWA function. Meanwhile, when it is determined that the non-detection of the smart key did not consecutively occur twice after the detection of the smart key occurred once (S309—No), the method may perform the step S307.

After the step S313, the method may perform a step S314 of determining whether there is an opened door. When it is determined that there is not an opened door (S314—No), the method may perform a step S315 of determining whether the gear is in the P range. When it is determined that the gear is in the P range (S315—Yes), the method may perform a step S316 of determining whether the driver seat is in the unoccupied state. When it is determined that the driver seat is not occupied (S316—Yes), the method may perform a step S317 of determining whether the remote start has been changed from the activated state to the inactivated state. When it is determined that the remote start has not been changed from the activated state to the inactivated state (S317—No), the method may perform a step S318 of determining whether the SWA USM is inactivated. When it is determined that the SWA USM is not inactivated (S318—No), the method may perform the step S313.

When it is determined that there is an opened door (S314—Yes), when it is determined that the gear is not in the P range (S315—No), when it is determined that the driver seat is not in the unoccupied state (S316—No), when it is determined that the remote start has been changed from the activated state to the inactivated state (S317—Yes) or when it is determined that the SWA USM is inactivated (S318—Yes), the method may restart from the beginning.

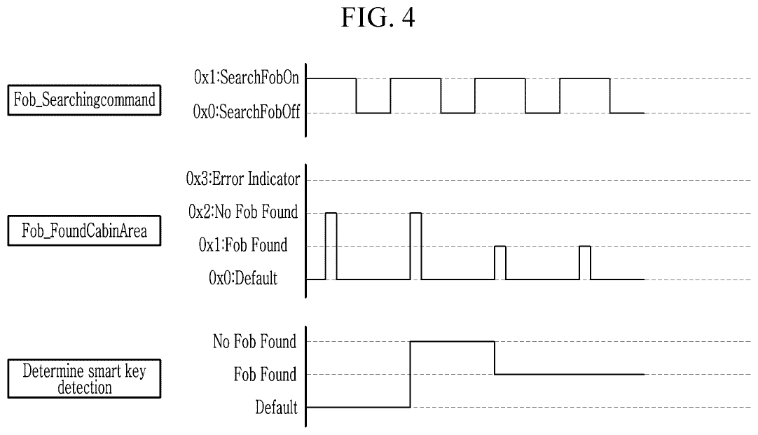

FIG. 4 to FIG. 6 are drawings for explaining an implementation example of an apparatus and method for controlling a vehicle door according to an embodiment.

Referring to FIG. 4, a search scenario of a FOB (i.e., smart key) may be proceeded as follows. First, the RGW may transmit a “Fob_Searchingcommand” to the BDC. Then, the BDC check whether the FOB exists through LF/RF communication and, depending on the result, may transmit a “Fob_FoundCabinArea” signal. When a “No Fob Found” signal is consecutively received twice, it may be determined that there is no smart key, and to the contrary, when a “Fob Found” signal is received once, it may be determined that there is the smart key. When a smart key detection-state is changed from “smart key found” to “smart key not found”, the SWA may operate.

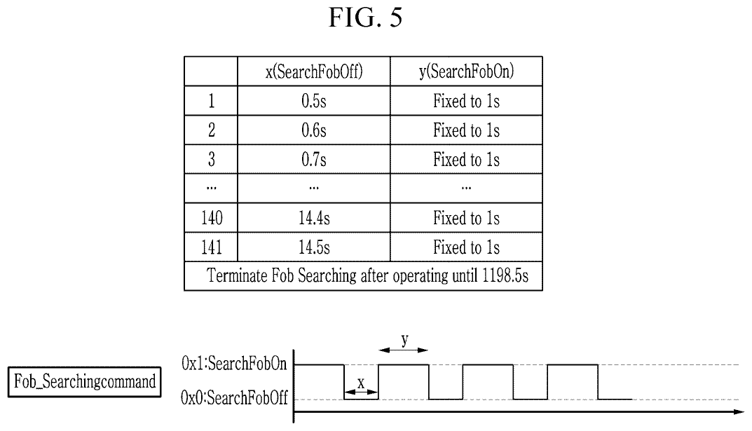

Referring to FIG. 5, in order to prevent battery discharge of the smart key, the transmission time of the FOB_Searchingcommand may be limited. This function may operate up to a maximum 1198.5 seconds, and thereafter, the FOB search may be terminated. According to the period table, the transmission cycle of the FOB_Searchingcommand may be variably set.

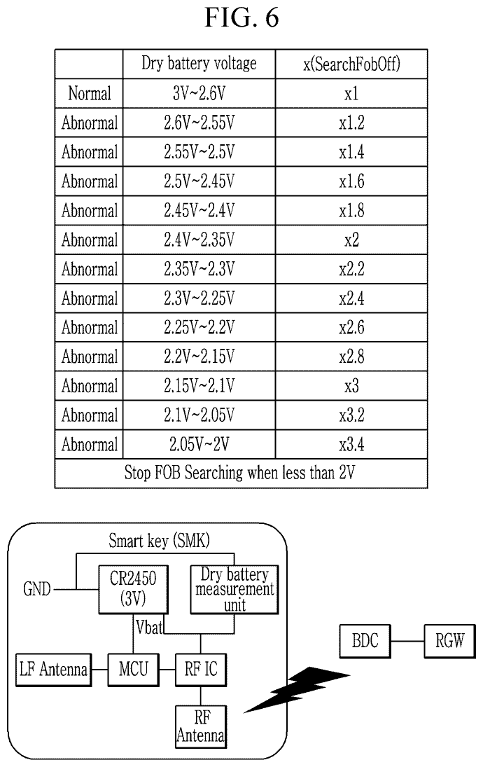

Referring to FIG. 6, in order to prevent battery discharge of the smart key, the transmission cycle of the FOB_Searchingcommand may be variably adjusted according to a dry battery voltage state of the smart key. The transmission cycle may be adjusted by multiplying a SearchFobOff value in the period table by a specific multiple, and SearchFobOn may always maintain the transmission time at 1 second. Through this, the battery consumption of the smart key may be efficiently managed.

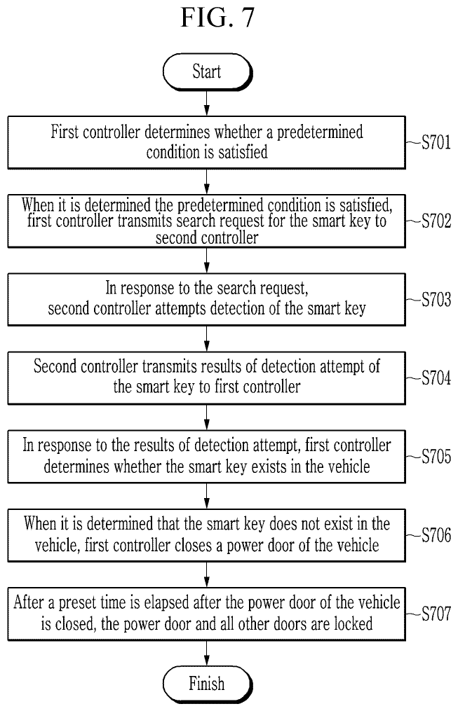

FIG. 7 is a drawing for explaining a method for controlling a vehicle door according to an embodiment.

Referring to FIG. 7, a method for controlling a vehicle door according to an embodiment may perform a step S701 of determining, by the first controller, whether the predetermined condition is satisfied, a step S702 of transmitting, by the first controller, the search request for the smart key to the second controller, a step S703 of attempting, by the second controller, the detection of the smart key, when it is determined that the predetermined condition is satisfied, in response to the search request, a step S704 of transmitting, by the second controller, the result of detection attempt of the smart key to the first controller, a step S705 of determining, by the first controller, whether the smart key exists in the vehicle, in response to the result of detection attempt, when it is determined that the smart key does not exist in the vehicle, a step S706 of closing, by the first controller, the power door of the vehicle, and after a preset time is elapsed after the power door of the vehicle is closed, and a step S707 of locking the power door and all other doors.

For more detailed information about the above method, reference can be made to the description of the embodiments described in this specification, so a redundant description is omitted here.

FIG. 8 is a drawing for explaining a computing device according to an embodiment.

Referring now to FIG. 8, the vehicle door control method and apparatus for according to the embodiments may be implemented by using a computing device 50. The computing device 50 may be implemented as various types of electronic devices, servers or similar devices, and its function may be implemented through a combination of software and hardware.

The computing device 500 may include at least one of a processor 510, a memory 530, a user interface input device 540, a user interface output device 550 and a storage device 560 that communicate with each other through a bus 520. The computing device 50 may include a network interface 570 electrically connected to a network 40. The network interface 570 may send or receive signals to and from other entities through the network 40.

The processor 510 may be implemented as various types of calculation devices, such as a microcontroller unit (MCU), an application processor (AP), a central processing unit (CPU), a graphic processing unit (GPU), a neural processing unit (NPU), a quantum processing unit (QPU), etc. The processor 510 is also a semiconductor device that executes instructions stored in the memory 530 or the storage device 560 and may play a key role in the system. Program codes and data stored in the memory 530 or the storage device 560 instruct the processor 510 to perform specific tasks, thereby enabling the overall operation of the system. In this way, the processor 510 may be configured to implement the various functions and methods described above with reference to FIGS. 1 to 7.

The memory 530 and storage device 560 may include various forms of volatile or non-volatile storage medium for storing and accessing data of the system. For example, the memory 530 may include a read-only memory (ROM) 531 and a random-access memory (RAM) 532. In some embodiments, the memory 530 may be built into the processor 510, in which case data transmission speeds between the memory 530 and the processor 510 may be very fast. In some other embodiments, the memory 530 may be disposed external to the processor 510, in which case the memory 530 may be connected to the processor 510 through various data buses or interfaces. This connection may be made through a variety of known means—for example, a peripheral component interconnect express (PCIe) interface for high-speed data transmission or a memory controller.

In some embodiments, at least some of the components or functions of a door control method and apparatus of a vehicle according to the embodiments may be implemented as a program or software executed on the computing device 50, and the program or software may be stored on a computer-readable recording medium or storage medium. Specifically, according to an embodiment, a computer-readable recording medium or storage medium may record a program for executing steps included in an implementation of a door control method and apparatus of a vehicle according to embodiments, on a computer including the processor 510 executing a program or instructions stored in the memory 530 or the storage device 560.

In some embodiments, at least some configurations or features of the vehicle door control method and apparatus according to the embodiments may be implemented using hardware or circuit of the computing device 50, or may be implemented as separate hardware or circuit that may be electrically connected to computing device 50.

In some embodiments, one or more non-transitory computer-readable media including an instruction executable by the computing device 50 may be provided, and the instruction may cause the computing device 50 to perform the operation, when executed by one or more processors of the computing device 50. Here, the operation may include configurations, functions, steps, or the like described in this specification in connection with a method and apparatus for controlling a vehicle door according to embodiments.

According to an embodiment, by controlling a vehicle door by using the smart key LF communication, the problem of deteriorating stability caused by Bluetooth communication instability in the conventional smart phone and the Bluetooth beacon-based digital key system can be improved.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A method for controlling a vehicle door, the method being performed by a first controller and a second controller implemented in a vehicle, the method comprising:
determining, by the first controller, whether a predetermined condition is satisfied;
transmitting, from the first controller to the second controller, a search request for a smart key in response to determining that the predetermined condition is satisfied;
attempting, by the second controller, detection of the smart key in response to the search request;
transmitting, from the second controller to the first controller, a result of the detection attempt;
determining, by the first controller, whether the smart key is located in the vehicle in response to the result of the detection attempt; and
causing, by the first controller, a power door of the vehicle to be closed in response to determining that the smart key is not located in the vehicle.

2. The method of claim 1, wherein determining whether the predetermined condition is satisfied comprises:
determining whether a smart walk away (SWA) is activated in the vehicle;
determining whether the vehicle is stopped in response to determining that the SWA is activated in the vehicle;
determining whether or not a driver seat of the vehicle is occupied in response to determining that the vehicle is stopped;
determining whether a remote start is inactivated in response to determining the driver seat of the vehicle is not occupied;
determining whether all other doors except for the power door are closed in response to determining that the remote start is inactivated; and
determining that the predetermined condition is satisfied in response to determining that the all other doors are closed.

3. The method of claim 1, wherein transmitting the search request for the smart key comprises:
accessing, by the first controller, a predetermined period table; and
transmitting, from the first controller to the second controller, the search request for the smart key according to a search proceeding cycle and a search stopping cycle stored in the period table.

4. The method of claim 3, wherein transmitting the search request for the smart key further comprises:
reading, by the first controller, a predetermined weight value table; and
applying, by the first controller, a weight value to the search stopping cycle, the weight value depending on a smart key battery state stored in the weight value table,
wherein transmitting the search request for the smart key comprises transmitting the search request for the smart key according to the search proceeding cycle stored in the period table and the search stopping cycle to which the weight value is applied.

5. The method of claim 3, wherein transmitting the search request for the smart key further comprises stopping, by the first controller, transmitting the search request for the smart key after a preset search request allowance time has elapsed after an initial request was transmitted.

6. The method of claim 1, wherein attempting detection of the smart key comprises attempting, by the second controller, location detection of the smart key through a low frequency (LF) or radio frequency (RF) communication.

7. The method of claim 1, wherein attempting detection of the smart key comprises attempting the detection of the smart key multiple times; and
wherein transmitting the result of the detection attempt comprises transmitting every result of the multiple attempts.

8. The method of claim 7, wherein determining whether the smart key is located in the vehicle comprises determining that the smart key is not located in the vehicle in response to a number of attempts without detecting the smart key being greater than or equal to a predetermined number.

9. The method of claim 1, further comprising locking all other doors after a predetermined time has elapsed after the power door of the vehicle has been closed.

10. The method of claim 9, further comprising inactivating or cancelling transmitting the search request for the smart key, causing the power door of the vehicle to be closed, and the locking all other doors, when an arbitrary button of the smart key is pressed, when a remote start is activated, and when a remote parking assist is activated.

11. An apparatus operating a vehicle, the apparatus comprising:
a first controller; and
a second controller;
wherein the first controller and second controller are configured to operate in combination to control a power door of the vehicle in a manner such that:
the first controller determines whether a predetermined condition is satisfied;
the first controller transmits a search request for a smart key to the second controller in response to determining that the predetermined condition is satisfied;
the second controller attempts detection of the smart key in response to the search request;
the second controller transmits a result of the detection attempt to the first controller;
the first controller determines whether the smart key is located in the vehicle in response to the result of the detection attempt; and
the first controller causes the power door of the vehicle to close in response to determining that the smart key is not located in the vehicle.

12. The apparatus of claim 11, wherein the first controller is configured to determine whether the predetermined condition is satisfied by:
determining whether a smart walk away (SWA) is activated in the vehicle;
determining whether the vehicle is stopped in response to determining that the SWA is activated in the vehicle;
determining whether a driver seat of the vehicle is occupied or not in response to determining that the vehicle is stopped;
determining whether a remote start is inactivated in response to determining that the driver seat of the vehicle is not occupied;
determining whether all other doors except for the power door are closed in response to determining that the remote start is inactivated; and
determining that the predetermined condition is satisfied in response to determining that the all other doors are closed.

13. The apparatus of claim 11, wherein the first controller is configured to transmit the search request for the smart key to the second controller by:
accessing a predetermined period table; and
transmitting the search request for the smart key to the second controller according to a search proceeding cycle and a search stopping cycle stored in the period table.

14. The apparatus of claim 13, wherein the first controller is further configured to transmit the search request for the smart key by accessing a predetermined weight value table and applying a weight value to the search stopping cycle, the weight value depending on a smart key battery state stored in the weight value table, and
wherein the first controller is configured to transmit the search request for the smart key to the second controller by transmitting the search request according to the search proceeding cycle stored in the period table and the search stopping cycle to which the weight value is applied.

15. The apparatus of claim 13, wherein the first controller is configured to transmit the search request for the smart key to the second controller and to stop transmitting the search request after a preset search request allowance time has elapsed after an initial request was transmitted.

16. The apparatus of claim 11, wherein the second controller is configured to attempt detection of the smart key through a low frequency (LF) or radio frequency (RF) communication.

17. The apparatus of claim 11, wherein the second controller is configured to attempt detection of the smart key by attempting the detection of the smart key multiple times and to transmit every result of the multiple detection attempts.

18. The apparatus of claim 17, wherein the first controller is configured to determine whether the smart key is located in the vehicle by determining that the smart key is not located in the vehicle in response to a number of attempts without detecting the smart key being greater than or equal to a predetermined number.

19. The apparatus of claim 11, wherein the first controller is configured to lock all other doors after a predetermined time has elapsed after the power door of the vehicle has been closed.

20. The apparatus of claim 19, wherein the first controller is configured to inactivate or cancel transmitting the search request for the smart key to the second controller, close the power door of the vehicle and lock all the other doors, when an arbitrary button of the smart key is pressed, when a remote start is activated, and when a remote parking assist is activated.
